(19) United States
(12) Patent Application Publication
(10) Pub. No.: US 2014/0354880 A1
(43) Pub. Date: Dec. 4, 2014

(54) Camera with Hall Effect Switch

(71) Applicant: Microsoft Corporation, Redmond, WA (US)

(72) Inventor: Amy Aimei Han, Portola Valley, CA (US)

(21) Appl. No.: 13/908,906

(22) Filed: Jun. 3, 2013

(51) Int. Cl. H04N 5/225; G03B 17/56

(52) U.S. Cl. CPC H04N 5/2252; G03B 17/561
USPC 348/376

(57) ABSTRACT

Various embodiments provide a wearable camera that can be worn by a user. The wearable camera includes one or more Hall effect switches that can be utilized to activate camera functionality. In at least some embodiments, the Hall effect switch or switches can comprise the only switches on the wearable camera. This can provide a high degree of waterproof protection for the camera.

### BACKGROUND

Physical buttons that reside on hardware devices, such as cameras, can pose design challenges, particularly when the hardware or camera has a small form factor. Physical buttons can also present problems insofar as allowing moisture to enter the interior of the hardware or camera.

### SUMMARY

This Summary is provided to introduce a selection of concepts in a simplified form that are further described below in the Detailed Description. This Summary is not intended to identify key features or essential features of the claimed subject matter.

Various embodiments provide a wearable camera that can be worn by a user. The wearable camera includes one or more Hall effect switches that can be utilized to activate camera functionality. In at least some embodiments, the Hall effect switch or switches can comprise the only switches on the wearable camera. This can provide a high degree of waterproof protection for the camera.

### BRIEF DESCRIPTION OF THE DRAWINGS

The detailed description references the accompanying figures. In the figures, the left-most digit(s) of a reference number identifies the figure in which the reference number first appears. The use of the same reference numbers in different instances in the description and the figures may indicate similar or identical items.

FIG. 1 is an example camera device in accordance with one or more embodiments.

FIG. 2 illustrates an example camera device in accordance with one or more embodiments.

FIG. 3 illustrates an example camera device in accordance with one or more embodiments.

FIG. 4 is a flow diagram that describes steps in a method in accordance with one or more embodiments.

FIG. 5 is a flow diagram that describes steps in a method in accordance with one or more embodiments.

FIG. 6 is a flow diagram that describes steps in a method in accordance with one or more embodiments.

FIG. 7 is diagram of a Hall effect switch in accordance with one or more embodiments.

FIG. 8 is a flow diagram that describes steps in a method in accordance with one or more embodiments.

### DETAILED DESCRIPTION

Overview

Various embodiments provide a wearable camera that can be worn by a user. The wearable camera includes one or more Hall effect switches that can be utilized to activate camera functionality. In at least some embodiments, the Hall effect switch or switches can comprise the only switches on the wearable camera. This can provide a high degree of waterproof protection for the camera. The Hall effect switches can be used to access any type of camera functionality, examples of which are provided below.

The camera can be worn in any suitable location. For example, the camera can be worn on a user's head such as, a way of example and not limitation, a hat-mounted camera, glasses-mounted camera, headband-mounted camera, helmet-mounted camera, and the like. Alternately or additionally, the camera can be worn on locations other than the user's head. For example, the camera can be configured to be mounted on the user's clothing.

Various other embodiments provide a wearable camera that is mountable on a user's clothing. The camera is designed to be unobtrusive and user-friendly insofar as being mounted away from the user's face so as not to interfere with their view. In at least some embodiments, the camera includes a housing and a clip mounted to the housing to enable the camera to be clipped onto the user's clothing. The camera is designed to be lightweight with its weight balanced in a manner that is toward the user when clipped to the user's clothing.

In one or more embodiments, the camera includes a replay mode. When the replay mode is selected, as through a Hall effect switch, the camera automatically captures image data, such as video or still images, and saves the image data to a memory buffer. In at least some embodiments, the size of the memory buffer can be set by the user to determine how much image data is to be collected. Once the memory buffer is full, the older image data is erased to make room for currently-captured image data. If an event occurs that the user wishes to memorialize through video or still images, a record button which, in at least some embodiments can comprise a Hall effect switch, can be activated which saves the image data from the beginning of the memory buffer and continues recording until the user presses or otherwise engages the record button again. In this manner, if an event occurs, the user is assured of capturing the event from a time t-x, where x is the length of the memory buffer, in time.

In the discussion that follows, a section entitled “Example Environment” describes an example environment in which the various embodiments can be utilized. Next, a section entitled “Replay Functionality” describes an example replay mode in accordance with one or more embodiments. Following this, a section entitled “Duel Encoding” describes an embodiment in which captured image data can be dual encoded in accordance with one or more embodiments. Next, a section entitled “Photo Log” describes an example photo log in accordance with one or more embodiments. Following this, a section entitled “Camera with Hall effect Switch” describes a camera with one or more Hall effect switches in accordance with one or more embodiments.

Consider now an example environment in which various embodiments can be practiced.

Example Environment

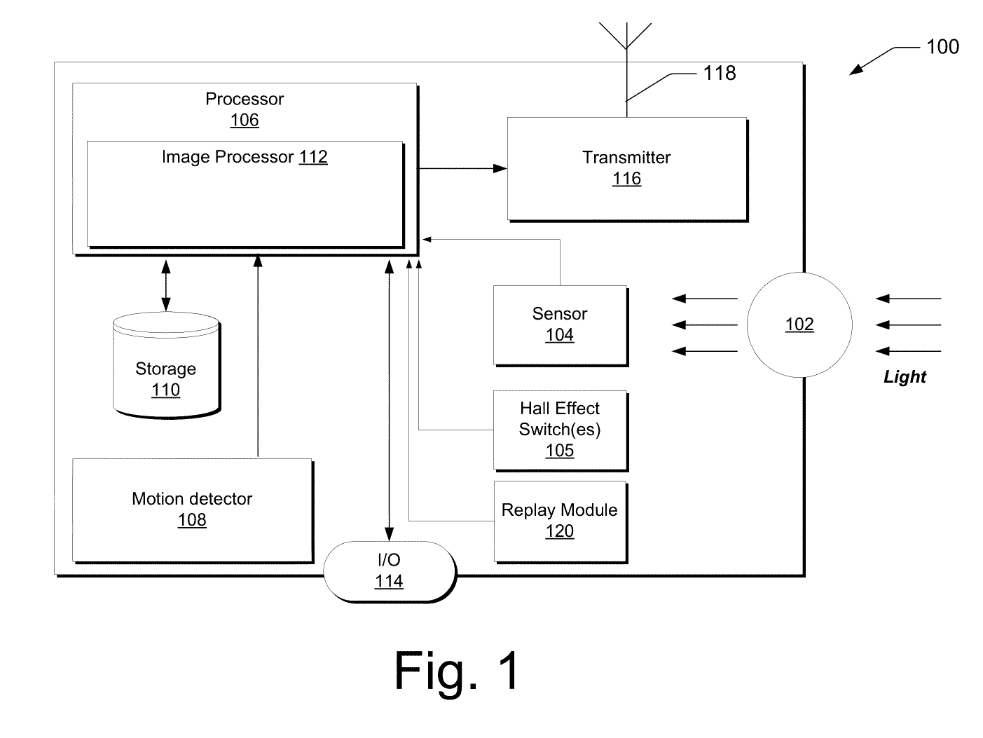

FIG. 1 illustrates a schematic of a camera device 100 in accordance with one or more embodiments. The camera device 100 includes a lens 102 having a focal length that is suitable for covering a scene to be pictured. In one embodiment, a mechanical device may be included with the lens 102 to enable auto or manual focusing of the lens. In another embodiment, the camera device 100 may be a fixed focus device in which no mechanical assembly is included to move the lens 102. A sensor 104 having a sensing surface (not shown) is also included to convert an image formed by the incoming light on the sensing surface of the sensor 104 into a digital format. The sensor 104 may include a charge-coupled device (CCD) or complementary metal oxide semiconductor (CMOS) image sensor for scanning the incoming light and creating a digital picture. Other technologies or devices may be used so long as the used device is capable of converting an image formed by the incoming light on a sensing surface into the digital form. Typically, these image detection devices determine the effects of light on tiny light sensitive devices and record the changes in a digital format.

It should be appreciated that the camera device 100 may include other components such as a battery or power source and other processor components that are required for a processor to operate. However, to avoid obfuscating the teachings, these well-known components are being omitted. In one embodiment, the camera device 100 does not include a view finder or a preview display. In other embodiments, however, a preview display may be provided. The techniques described herein can be used in any type of camera, and are particularly effective in small, highly portable cameras, such as those implemented in mobile telephones and other portable user equipment. Thus, in one embodiment, the camera device 100 includes hardware or software for making and receiving phone calls. Alternately, the camera device 100 can be a dedicated, stand-alone camera.

The camera device 100 also includes one or more Hall effect switches 105. The Hall effect switches can be utilized to access and activate any suitable type of camera functionality, examples of which are provided above and below. In the illustrated and described example, the Hall effect switch or switches 105 are coupled to the processor 106 which receives input from the switches to enable access and activation of various camera functionality described below.

In at least some embodiments, the camera device 100 further includes a motion detector 108 that can include an accelerometer and, in some embodiments, a gyroscope. The accelerometer is used for determining the direction of gravity and acceleration in any direction. The gyroscope may also be used either in addition to the accelerometer or instead of the accelerometer. The gyroscope can provide information about how the rotational angle of the camera device 100 changes over time. Any other type of sensor may be used to detect the camera's motion. Using the rotational angle, an angle of rotation of the camera device 100 may be calculated, if the camera device 100 is rotated.

Further included is an input/output (I/O) port 114 for connecting the camera device 100 to an external device, including a general purpose computer. The I/O port 114 may be used for enabling the external device to configure the camera device 100 or to upload/download data. In one embodiment, the I/O port 114 may also be used for streaming video or pictures from the camera device 100 to the external device. In one embodiment, the I/O port may also be used for powering the camera device 100 or charging a rechargeable battery (not shown) in the camera device 100.

The camera device 100 may also include an antenna 118 that is coupled to a transmitter/receiver (Tx/Rx) module 116. The Tx/Rx module 116 is coupled to a processor 106. The antenna 118 may be fully or partly exposed outside the body of the camera device 100. However, in another embodiment, the antenna 118 may be fully encapsulated within the body of the camera device 100. The Tx/Rx module 116 may be configured for Wi-Fi transmission/reception, Bluetooth transmission/reception or both. In another embodiment, the Tx/Rx module 116 may be configured to use a proprietary protocol for transmission/reception of the radio signals. In yet another embodiment, any radio transmission or data transmission standard may be used so long as the used standard is capable of transmitting/receiving digital data and control signals. In one embodiment, the Tx/Rx module 116 is a low power module with a transmission range of less than ten feet. In another embodiment, the Tx/Rx module 116 is a low power module with a transmission range of less than five feet. In other embodiments, the transmission range may be configurable using control signals received by the camera device 100 either via the I/O port 114 or via the antenna 118.

The camera device 100 further includes a processor 106. The processor 106 is coupled to the sensor 104 and the motion detector 108. The processor 106 may also be coupled to storage 110, which, in one embodiment, is external to the processor 106. The storage 110 may be used for storing programming instructions for controlling and operating other components of the camera device 100. The storage 110 may also be used for storing captured media (e.g., pictures and/or videos). In another embodiment, the storage 110 may be a part of the processor 106 itself.

In one embodiment, the processor 106 may include an image processor 112. The image processor 112 may be a hardware component or may also be a software module that is executed by the processor 106. It may be noted that the processor 106 and/or the image processor 112 may reside in different chips. For example, multiple chips may be used to implement the processor 106. In one example, the image processor 112 may be a Digital Signal Processor (DSP). The image processor can be configured as a processing module, that is a computer program executable by a processor. In at least some embodiments, the processor 112 is used to process a raw image received from the sensor 104 based, at least in part, on the input received from the motion detector 108. Other components such as Image Signal Processor (ISP) may be used for image processing.

In one embodiment, the storage 110 is configured to store both raw (unmodified image) and the corresponding modified image. In one or more embodiments, the storage 110 can include a memory buffer, such as a flash memory buffer, that can be used as a circular buffer to facilitate capturing image data when the camera is set to a replay mode that is supported by replay module 120. The replay module 120 can be implemented in connection with any suitable hardware, software, firmware, or combination thereof. When the replay mode is selected, the camera automatically captures image data, such as video or still images, and saves the image data to the memory buffer. In at least some embodiments, the size of the memory buffer can be set by the user to determine how much image data is to be collected. If an event occurs that the user wishes to memorialize through video or still images, a record button, such as a Hall effect switch, can be activated which saves the image data from the beginning of the memory buffer and continues recording until the user presses the record button again. In this manner, if an event occurs, the user is assured of capturing the event from a time t-x, where x is the length of the memory buffer, in time.

A processor buffer (not shown) may also be used to store the image data. The pictures can be downloaded to the external device via the I/O port 114 or via the wireless channels using the antenna 118. In one embodiment, both unmodified and modified images are downloaded to the external device when the external device sends a command to download images from the camera device 110. In one embodiment, the camera device 100 may be configured to start capturing a series of images at a selected interval.

In one embodiment, a raw image from the sensor 104 is inputted to an image processor (such as an ISP) for image processing or blur detection. After image processing is applied to the image outputted by the image processor, the modified image is encoded. The image encoding is typically performed to compress the image data.

In an example embodiment, the camera device 100 may not include the components for processing the image captured by the sensor 104. Instead, the camera device 100 may include programming instructions to transmit the raw image after extracting the image from the sensor 104 to a cloud based processing system that is connected to the camera device 100 via the Internet or a local area network. The cloud based system is configured to receive the raw image and process the image or images as described above and below. The encoded image is then either stored in a selected cloud based storage or the image is sent back to the camera device 100 or to any other device according to a user configuration. The use of a cloud based image processing system can reduce a need for incorporating several image processing components in each camera device, thus making a camera device lighter, more energy efficient and cheaper.

In another example embodiment, instead of a cloud based image processing, the camera device 100 may send either a raw image or the image processed through an image processor to another device, e.g., a mobile phone or a computer. The image may be transmitted to the mobile phone (or a computer) for further processing via Wi-Fi, Bluetooth or any other type of networking protocol that is suitable for transmitting digital data from one device to another device. After the mobile device receives the image or images, according to one or more embodiments described herein, the produced image may be saved to local storage on the device, transferred for storage in a cloud based storage system, or transmitted to another device, according to user or system configurations.

In one embodiment, the native image processing system in the camera device 100 may produce images and/or videos in a non-standard format. For example, a 1200×1500 pixel image may be produced. This may be done by cropping, scaling, or using an image sensor with a non-standard resolution. Since methods for transforming images in a selected standard resolution are well-known, there will be no further discussion on this topic.

Various embodiments described above and below can be implemented utilizing a computer-readable storage medium that includes instructions that enable a processing unit to implement one or more aspects of the disclosed methods as well as a system configured to implement one or more aspects of the disclosed methods. By “computer-readable storage medium” is meant all statutory forms of media. Accordingly, non-statutory forms of media such as carrier waves and signals per se are not intended to be covered by the term “computer-readable storage medium”.

As noted above, camera device 100 can assume any suitable form of wearable camera. The camera can be worn in any suitable location relative to a user. For example, the camera can be worn on a user's head such as, by a way of example and not limitation, a hat-mounted camera, glasses-mounted camera, headband-mounted camera, helmet-mounted camera, and the like. Alternately or additionally, the camera can be worn on locations other than the user's head. For example, the camera can be configured to be mounted on the user's clothing or other items carried by a user, such as a backpack, purse, briefcase, and the like.

In the example provided just below, a wearable camera is described in the context of a camera that is mountable on the user's clothing. It is to be appreciated and understood, however, that other types of non-clothing mountable, wearable cameras can be utilized without departing from the spirit and scope of the claimed subject matter.

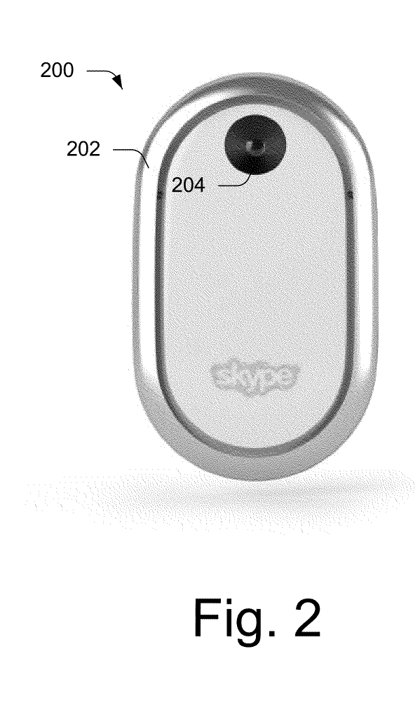

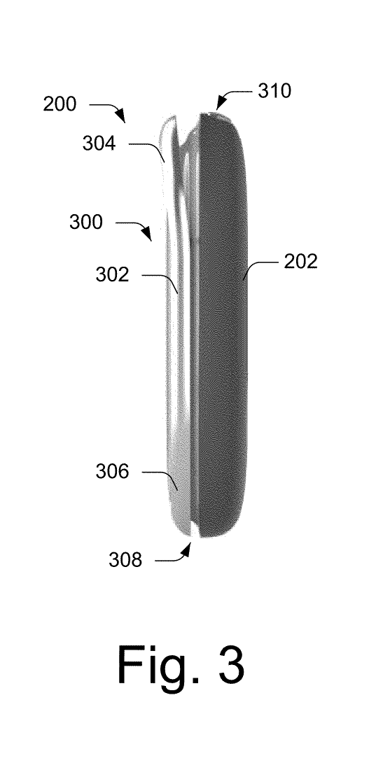

Moving on to FIGS. 2 and 3, consider the following. FIG. 2 illustrates an example camera device 200 in a front elevational view, while FIG. 3 illustrates the camera device 200 in a side elevational view. The camera device 200 includes a housing 202 that contains the components described in FIG. 1. Also illustrated is a camera lens 204 (FIG. 2) and a fastening device 300 (FIG. 3) in the form of a clip that operates in a manner that is similar to a clothespin. Specifically, the fastening device 300 includes a prong 302 with a body having a thumb-engageable portion 304. The body extends along an axis away from the thumb-engageable portion 304 toward a distal terminus 306. A spring mechanism, formed by the body or separate from and internal relative to the body, enables prong 302 to be opened responsive to pressure being applied to the thumb-engageable portion 304. When opened, a piece of clothing can be inserted into area 308. When the thumb-engageable portion 304 is released, the clothing is clamped in place by the prong 302 thereby securely mounting the camera device on a piece of clothing. For example, the camera device can be mounted, as described above, on a necktie, blouse, shirt, pocket, and the like.

In addition, camera device 200 can include a number of input buttons shown generally at 310. The input buttons can include, by way of example and not limitation, an input button to take a still picture, an input button to initiate the replay mode, an input button to initiate a video capture mode, and an input button to enable the user to adjust the buffer size that is utilized during the replay mode. One or more of these buttons can be implemented as a Hall effect switch. In at least some embodiments, all external input provided to the camera by a user can be provided by one or more Hall effect switches. As will be appreciated, Hall effect switches can promote protection from moisture and water to provide a high degree of “water proofness”. It is to be appreciated and understood that the various input buttons can be located anywhere on the camera device 200.

It may be noted that even though the camera device 200 is shown to have a particular shape, the camera device 100 can be manufactured in any shape shape and size suitable and sufficient to accommodate the above described components of the camera device 100. The housing 202 of the camera device may be made of a metal molding, a synthetic material molding or a combination thereof. In other embodiments, any suitable type of material may be used to provide a durable and strong outer shell for typical portable device use.

In addition, the fastening device 300 can comprise any suitable type of fastening device. For example, the fastening device may be a simple slip-on clip, a crocodile clip, a hook, a Velcro or a magnet or a piece of metal to receive a magnet. The camera device 200 may be affixed permanently or semi-permanently to another object using the fastening device 300.

Generally, any of the functions described herein can be implemented using software, firmware, hardware (e.g., fixed logic circuitry), or a combination of these implementations. The terms “module,” “functionality,” “component” and “logic” as used herein generally represent software, firmware, hardware, or a combination thereof. In the case of a software implementation, the module, functionality, or logic represents program code that performs specified tasks when executed on a processor (e.g., CPU or CPUs). The program code can be stored in one or more computer readable memory devices. The features of the techniques described below are platform-independent, meaning that the techniques may be implemented on a variety of commercial computing platforms having a variety of processors.

For example, the camera device 200 may include a computer-readable medium that may be configured to maintain instructions that cause the camera's software and associated hardware to perform operations. Thus, the instructions function to configure the camera's software and associated hardware to perform the operations and in this way result in transformation of the software and associated hardware to perform functions. The instructions may be provided by the computer-readable medium to the camera device through a variety of different configurations.

One such configuration of a computer-readable medium is signal bearing medium and thus is configured to transmit the instructions (e.g., as a carrier wave) to the camera device, such as via a network. The computer-readable medium may also be configured as a computer-readable storage medium and thus is not a signal bearing medium. Examples of a computer-readable storage medium include a random-access memory (RAM), read-only memory (ROM), an optical disc, flash memory, hard disk memory, and other memory devices that may use magnetic, optical, and other techniques to store instructions and other data.

Having considered an example operating environment in accordance with one or more embodiments, consider now a discussion of replay functionality and other features that can be provided by the camera device.

Replay Functionality

As noted above, camera device 200 includes a replay mode. When the replay mode is selected, as by the user pressing an input button associated with initiating the replay mode, the camera automatically captures image data, such as video or still images, and saves the image data to a memory buffer. In one or more embodiments, the memory buffer is a circular buffer that saves an amount of image data, for example video data. When the memory buffer is full of image data, it deletes the oldest image data to make room for newly recorded image data. This continues until either the user exits the replay mode or presses a button associated with initiating video capture, i.e. the “record” button.

In at least some embodiments, the size of the memory buffer can be set by the user to determine how much image data is to be collected. As an example, the user might set the length of the memory buffer to correspond to 5 seconds, 30 seconds, 1 minute, 2 minutes, and longer.

Assume now that an event occurs that the user wishes to memorialize through video or still images. Assume also that the user has initiated the replay mode so that video data is currently being buffered in the memory buffer. By pressing the “record” button or otherwise engaging the record button in the event it is embodied as a Hall effect switch, the video data is now saved from the beginning of the memory buffer and recording continues until the user presses the record button again. In this manner, if an event occurs, the user is assured of capturing the event from a time t-x, where x is the length of the memory buffer, in time. So, for example, if the user initially set the memory buffer to capture 2 minutes worth of video data, by pressing the “record” button, the last 2 minutes of video data will be recorded in addition to the currently recorded video data.

In one or more embodiments, the memory buffer comprises flash memory. When the user presses or engages the “record” button and the camera device is in replay mode, a pointer is used to designate where, in flash memory, the beginning of the captured video data occurs, e.g., the beginning of the last 2 minutes of video data prior to entering the “record” mode. In other embodiments, the video data captured during replay mode and “record” mode can be written to an alternate storage location.

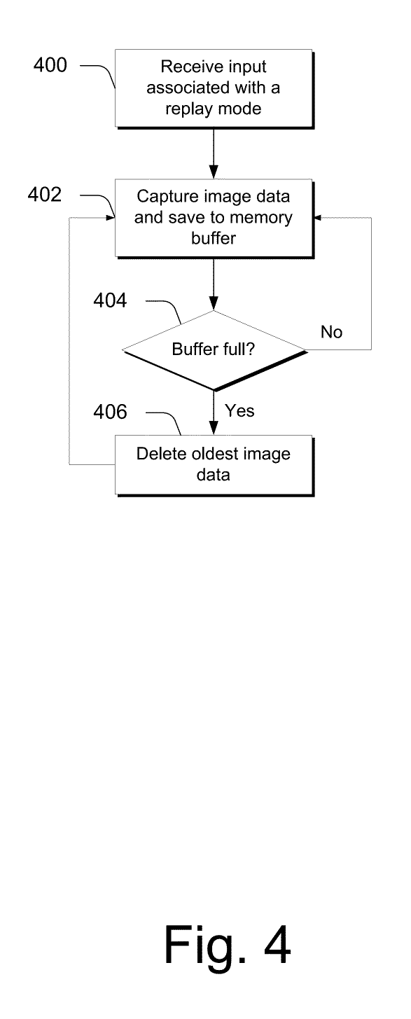

FIG. 4 is a flow diagram that describes steps in a method in accordance with one or more embodiments. The method can be performed in connection with any suitable hardware, software, firmware, or combination thereof. In at least some embodiments, the method is performed by a suitably-configured camera device such as the one described above.

Step 400 receives input associated with a replay mode. This step can be performed in any suitable way. For example, in at least some embodiments, this step can be performed by receiving input from the user via a suitable input device on the camera device. In one or more embodiments, the input device can comprise a Hall effect switch, as described below in more detail. Responsive to receiving the input associated with the replay mode, step 402 captures image data and saves the image data to a memory buffer. Step 404 ascertains whether the buffer is full. If the buffer is not full, the method returns to step 402 and continues to capture image data and save image data to the memory buffer. If, on the other hand, the buffer is full, step 406 deletes the oldest image data in the memory buffer and returns to step 402 to capture subsequent image data.

This process continues until either the user presses or otherwise engages the “record” button or exits the replay mode.

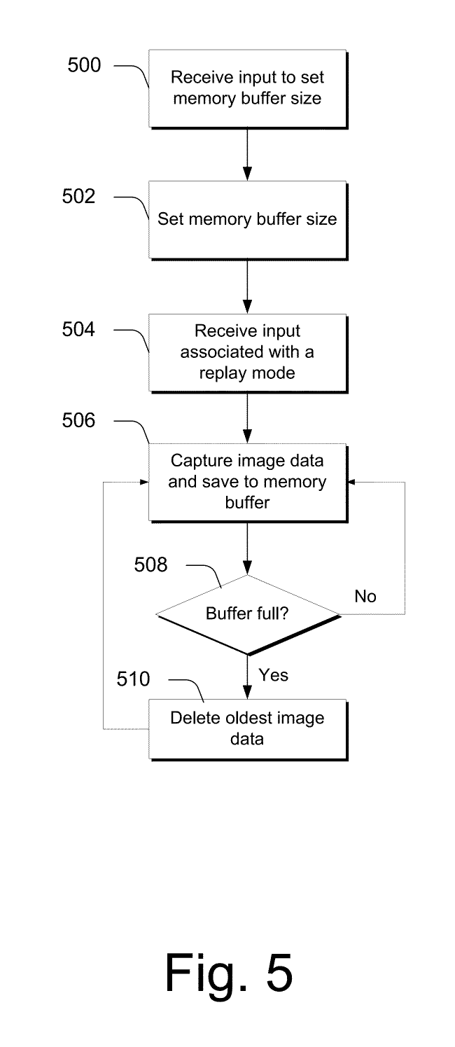

FIG. 5 is a flow diagram that describes steps in another method in accordance with one or more embodiments. The method, which allows a user to set the camera device's memory buffer size, can be performed in connection with any suitable hardware, software, firmware, or combination thereof. In at least some embodiments, the method is performed by a suitably-configured camera device such as the one described above.

Step 500 receives input to set a memory buffer size. The step can be performed in any suitable way. For example, in at least some embodiments, the step can be performed by receiving user input by way of a suitably-configured input mechanism such as a button on the camera device. Alternately, this step can be performed by receiving user input by way of a Hall effect switch on the camera device. Responsive to receiving this input, step 502 sets the memory buffer size.

Step 504 receives input associated with a replay mode. This step can be performed in any suitable way. For example, in at least some embodiments, this step can be performed by receiving input from the user via a suitable input device on the camera device. The input device can comprise, in at least some embodiments, a Hall effect switch. This can be the same Hall effect switch, or a different Hall effect switch from the one mentioned just above.

Responsive to receiving the input associated with the replay mode, step 506 captures image data and saves the image data to a memory buffer. Step 508 ascertains whether the buffer is full. If the buffer is not full, the method returns to step 506 and continues to capture image data and save image data to the memory buffer. If, on the other hand, the buffer is full, step 510 deletes the oldest image data in the memory buffer and returns to step 506 to capture subsequent image data.

This process continues until either the user presses or otherwise engages the “record” button or exits the replay mode.

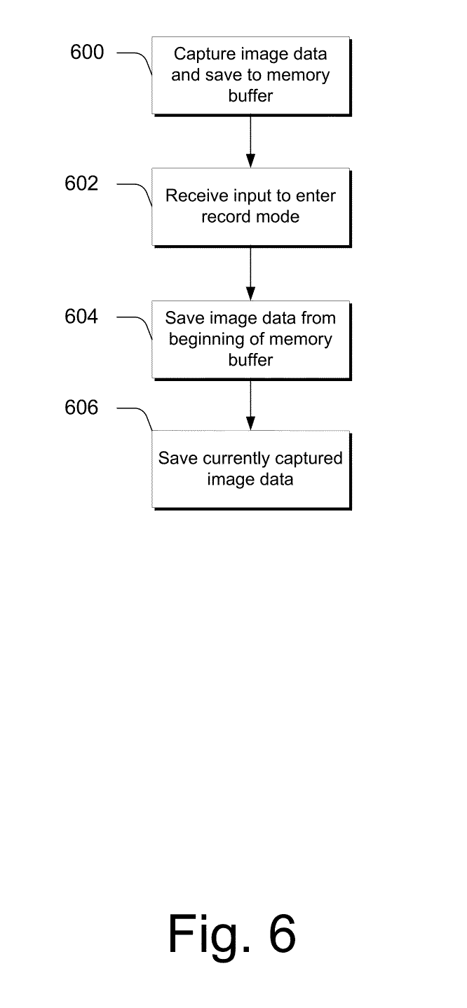

FIG. 6 is a flow diagram that describes steps in another method in accordance with one or more embodiments. The method can be performed in connection with any suitable hardware, software, firmware, or combination thereof. In at least some embodiments, the method is performed by a suitably-configured camera device such as the one described above.

Step 600 captures image data and saves the image data to a memory buffer. The step can be performed in any suitable way. For example, the step can be performed as described in connection with FIG. 4 or 5. Step 602 receives input to enter the camera device's record mode. This step can be performed, for example, by receiving user input by way of a “record” button. In at least some embodiments, the “record” button is implemented as a Hall effect switch. Responsive to receiving the input to enter record mode, step 604 saves image data from the beginning of the memory buffer. This step can be performed in any suitable way. For example, the step can be performed by setting a pointer to point to the beginning of the memory buffer. Step 606 saves currently captured image data in addition to the image data from the beginning of the memory buffer. This step can be performed until the user presses or otherwise engages the “record” button once more.

Having considered an example replay mode and how it can be implemented with a suitably-configured camera device, consider now aspects of a dual encoding process.

Dual Encoding

In one or more embodiments, the camera device's processor 106 (FIG. 1) is configured to encode image data at different levels of resolution. For example, the camera device can encode image data at a low level of resolution and at a high level of resolution as well. Any suitable levels of resolution can be utilized. In at least some embodiments, the low level of resolution is Quarter-VGA (e.g., 320×240) and the high level of resolution is 720p (e.g., 1280×720).

Encoding image data at different resolutions levels can enhance the user's experience insofar as giving the user various options to transfer the saved image data. For example, at lower resolution levels, the captured image data can be streamed to a device such as a smart phone. Alternately or additionally, at higher resolution levels, when the user has Wi-Fi accessibility, they can transfer the image data to a network device such as a laptop or desktop computer.

Having considered a dual encoding scenario, consider now aspects of a photo log that can be constructed using the principles described above.

Photo Log

Photo log refers to a feature that enables a user to log their day in still photos at intervals of their own choosing. So, for example, if the user wishes to photo log their day at every 3 minutes, they can provide input to the camera device by, for example, a Hall effect switch, so that every 3 minutes the camera automatically takes a still photo and saves it. At the end of the day, the user will have documented their day with a number of different still photos.

In at least some embodiments, the photo log feature can work in concert with the replay mode described above. For example, if the user has entered the replay mode by causing image data to be captured and saved to the memory buffer, the camera device's processor can process portions of the captured video data at defined intervals to provide the still photos. This can be performed in any suitable way. For example, the camera device's processor can process the video data on the camera's photosensor and read predefined areas of the photosensor to process the read areas into the still photos. In some instances the photo format is a square format so that the aspect ratio is different from that aspect ratio of the video data.

Having considered an example photo log feature, consider now how this feature can be used in connection with the camera embodiments described below.

Camera with Hall Effect Switch

As noted above, input can be received by the camera by way of one or more Hall effect switches. Briefly, Hall effect switches are switches that are activated by an external magnetic field. The output signal from a Hall effect switch or sensor is the function of magnetic field density around the camera device. When the magnetic flux density around the sensor exceeds a certain preset threshold, the sensor detects it and generates an output voltage called a Hall effect voltage.

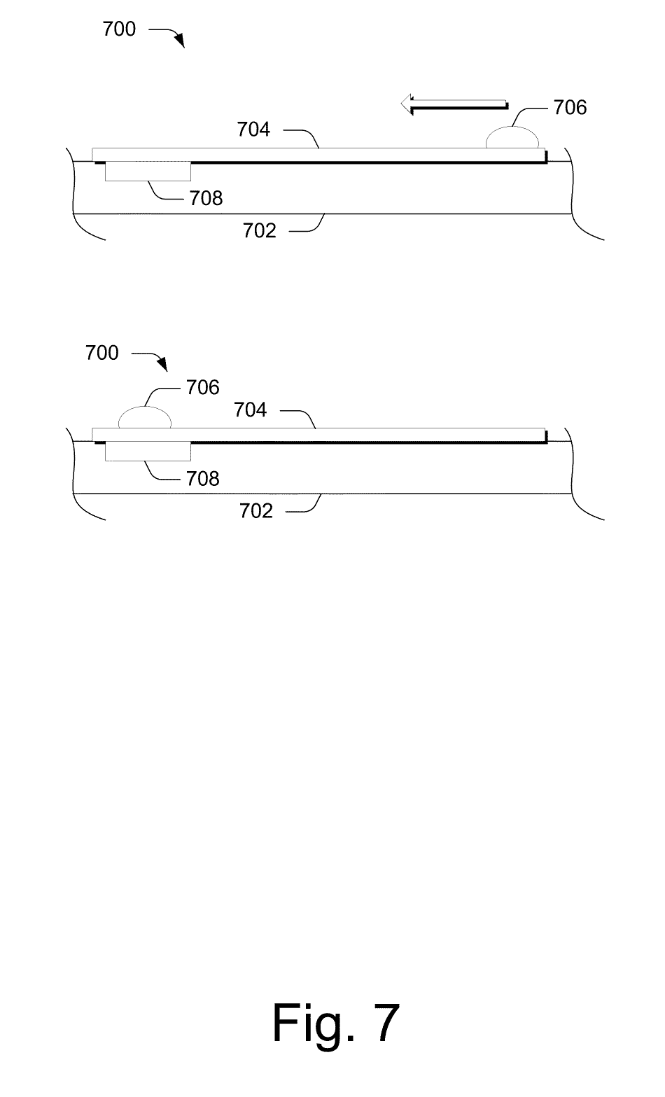

As an example, consider FIG. 7 which illustrates a portion of the camera device 700. Camera device portion 700 includes a housing portion 702, a support structure 704, a magnet 706 that rides along the support structure 704 and a Hall effect sensor 708 inside housing 702. In operation, magnet 706 can be moved in the direction of arrow toward the Hall effect sensor 708. When the magnet 706 is in the position shown in the upper diagram, the switch is in the “OFF” position. When the magnet 706 is the position shown in the lower diagram, the switch is in the “ON” condition, as will be appreciated by the skilled artisan.

As noted above, the Hall effect switch can be used to access and activate any suitable type of camera functionality, examples of which are provided above.

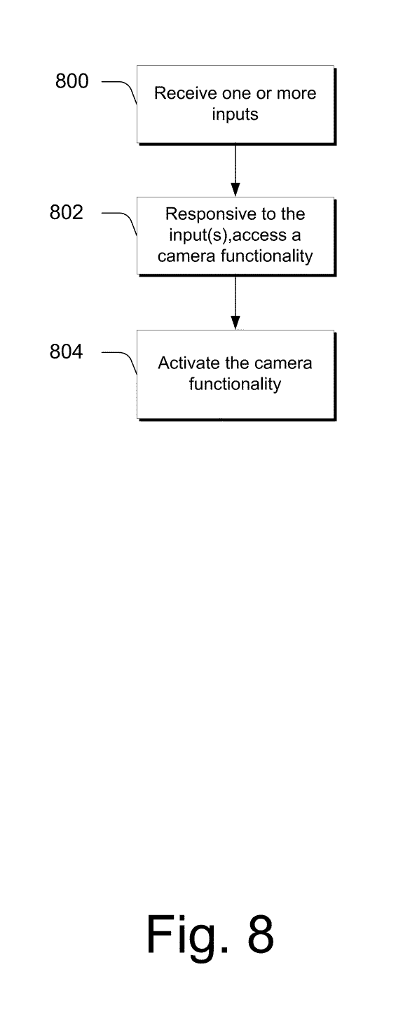

FIG. 8 is a flow diagram that describes steps in another method in accordance with one or more embodiments. The method can be performed in connection with any suitable hardware, software, firmware, or combination thereof. In at least some embodiments, the method is performed by a suitably-configured camera device such as the one described above.

Step 800 receives one or more inputs by way of one or more Hall effect switches. Responsive to receiving the input(s), step 802 accesses a camera functionality that is associated with the input that was received. As noted above, any suitable type of functionality can be accessed, examples of which are described above. Step 804 activates the camera functionality. This step can be performed in any suitable way.

In at least some embodiments, the camera device can include multiple Hall effect switches, each of which is mapped to a different functionality. In this case, the method described in FIG. 8 can be performed for each Hall effect switch.

### CONCLUSION

Various embodiments provide a wearable camera that can be worn by a user. The wearable camera includes one or more Hall effect switches that can be utilized to activate camera functionality. In at least some embodiments, the Hall effect switch or switches can comprise the only switches on the wearable camera. This can provide a high degree of waterproof protection for the camera. The Hall effect switches can be used to access any type of camera functionality, examples of which are provided below.

Although the embodiments have been described in language specific to structural features and/or methodological acts, it is to be understood that the various embodiments defined in the appended claims are not necessarily limited to the specific features or acts described. Rather, the specific features and acts are disclosed as example forms of implementing the various embodiments.

What is claimed is:

1. A camera device comprising:
a housing;
a camera lens supported by the housing and configured to enable capture of image data;
a fastening device on the housing and configured to enable the camera device to be worn by a user;
one or more Hall effect switches configured to enable access to camera device functionality;
a processor configured to:
receive input from the one or more Hall effect switches;
responsive to receiving the input, access one or more camera functionalities, and
activate the one or more camera functionalities.

2. The camera device of claim 1, wherein the camera device functionality enables the camera device to enter an automatic photo-capturing mode in which photos are automatically taken at one or more intervals.

3. The camera device of claim 1, wherein the camera device functionality enables the camera device to take a photograph.

4. The camera device of claim 1, wherein the camera device functionality enables the camera device to take a video.

5. The camera device of claim 1, wherein the camera device functionality enables the camera device to perform a function other than capturing an image.

6. The camera device of claim 1, wherein the fastening device is configured to enable the camera device to be mounted on a user's clothing.

7. The camera device of claim 1, wherein the fastening device is configured to enable the camera device to be mounted on a location other than a user's clothing.

8. A computer-implemented method comprising:
receiving, with a wearable camera, input by way of a Hall effect switch;
responsive to receiving said input, accessing a camera functionality; and
activating the camera functionality.

9. The method of claim 8, wherein said camera functionality enables the camera device to enter an automatic photo-capturing mode in which photos are automatically taken at one or more intervals.

10. The method of claim 8, wherein the camera functionality enables the camera device to take a photograph.

11. The method of claim 8, wherein the camera functionality enables the camera device to take a video.

12. The method of claim 8, wherein the camera functionality enables the camera device to perform a function other than capturing image.

13. The method of claim 8, wherein the wearable camera is configured to be wearable on a user's clothing.

14. The method of claim 8, wherein the wearable camera is configured to be mounted on a location other than a user's clothes.

15. A camera device comprising:
a housing;
a camera lens supported by the housing and configured to enable capture of image data;
one or more Hall effect switches configured to enable access to camera device functionality;
a processor configured to:
receive input from the one or more Hall effect switches;
responsive to receiving the input, access one or more camera functionalities, and
activate the one or more camera functionalities.

16. The camera device of claim 15, wherein the camera device functionality enables the camera device to enter an automatic photo-capturing mode in which photos are automatically taken at one or more intervals.

17. The camera device of claim 15, wherein the camera device functionality enables the camera device to take a photograph.

18. The camera device of claim 15, wherein the camera device functionality enables the camera device to take a video.

19. The camera device of claim 15, wherein the camera device functionality enables the camera device to perform a function other than capturing an image.

20. The camera device of claim 15, wherein the camera device functionality enables a user to set a memory buffer size.
